(19) United States
(12) Patent Application Publication
(10) Pub. No.: US 2004/0112453 A1
(43) Pub. Date: Jun. 17, 2004

(54) Multilayer pipe for transporting fuel

(76) Inventors: Patrick Bremard, Reims (FR); Pierre Milhas, Vitry Le Francois (FR)

Correspondence Address: YOUNG & THOMPSON, 745 SOUTH 23RD STREET 2ND FLOOR, ARLINGTON, VA, 22202

(21) Appl. No.: 10/470,095

(22) PCT Filed: Apr. 9, 2002
(86) PCT No.: PCT/FR02/01227

(30) Foreign Application Priority Data
Apr. 13, 2001 (FR) 01/05122

(51) Int. Cl. F16L 11/00

(52) U.S. Cl. 138/137; 138/141; 428/36.91

(57) ABSTRACT

The invention concerns a multilayer pipe comprising an outer layer, an intermediate layer and an inner layer, made of thermoplastic material, the inner and outer layers containing additives making the layers conductive.

The present invention relates to a multilayer hose used in particular in fuel supply circuits in motor vehicle engines, e.g. for pumping fuel from a tank.

In a motor vehicle, the fuel is generally pumped from the tank by means of a pump (or suction plate) connected firstly to the fuel supply circuit of the engine of the motor vehicle, and secondly, by means of a hose, to a filter carried by a tracking element for tracking the level of the fuel in the tank.

The hose is generally made of rubber.

Unfortunately, one of the constraints associated with the design of tanks, and in particular metal tanks and more particularly tanks made of steel, relates to evacuating electrostatic charge accumulated by friction with the fuel, so as to prevent the risk of an electrostatic discharge producing an electric arc capable. of igniting the fuel or the fuel vapors contained in the tank. Electrostatic charge is generally evacuated by grounding the parts constituting the tank. It is therefore necessary for parts that are made of plastics material, and in particular the hose connected to the pump and to the filter, to be conductive.

It is therefore advantageous to make the hose out of a plastics material that has been made conductive or more conductive by adding conductive fillers such as carbon black or carbon fibers. However, the addition of conductive fillers generally contributes to reducing the mechanical strength of the hose. Furthermore, such conductive plastics materials are very costly.

In the invention, a multilayer hose is proposed comprising an outer layer, an intermediate layer, and an inner layer which are made of thermoplastic material, the inner and outer layers including additives making the layers conductive.

The additives used can be metal particles, metal ions, fibers, or carbon powder . . . and they are preferably selected with a view to obtaining inner and outer layers with surface resistivity of less than about 10⁶ ohms.

The hose made in this way presents the advantage of being conductive while not being costly, and of having good mechanical properties imparted, in particular, by the intermediate layer.

The layers are advantageously made from the same material.

Since the layers are made from the same material, said layers adhere together strongly, thereby reinforcing the mechanical strength of the hose.

In a first embodiment, the inner layer is made of a thermoplastic material that has been made conductive, such as polyamide 12, e.g. such as those referenced X7395 or LX9102 produced by the supplier CREANOVA, or polyamide 6, e.g. such as that referenced GRILON by the supplier EMS CHEMIE or those produced by the supplier RHODIA.

The intermediate layer is made of a thermoplastic material identical to that of the inner layer but not conductive. The plastics material used is, for example, polyamide 12 referenced LX9002 by the supplier CREANOVA, or polyamide 6 referenced GRILON R47 by the supplier EMS CHEMIE.

The outer layer is made in a conductive thermoplastic material identical to that of the inner layer.

Other thermoplastic materials can be used to make the hose, the choice of said materials being dictated, for example, by the compatibility of said materials, in particular their chemical compatibility, with the fluid conveyed, their mechanical properties, their ability to withstand high temperatures . . . depending on the application envisaged.

Thus, in a second embodiment, polyolefins, and in particular polyethylene, can be used. For example, the inner layer and the outer layer are of a polyethylene that has been made conductive by carbon black, such as that of grade 902 produced by the supplier CABOT, and the intermediate layer is of common high density polyethylene such as those produced by the suppliers ATOFINA, ELENAC, or SOLVAY.

In a third embodiment, polyesters, and in particular polybutylene terphthalate, are used. For example, the inner layer and the outer layer are of conductive polybutylene terphthalate, such as that referenced GRILPET ESD by the supplier EMS CHEMIE, and the intermediate layer is of polybutylene terphthalate, such as that referenced GRILPET B24 by the same supplier.

In a fourth embodiment, the hose can also be made based on a polyether-ester copolymer, such as that referenced HYTREL by the supplier DUPONT DE NEMOURS.

In a fifth embodiment, the inner and outer layers are made of a conductive polyamide 6, such as that referenced GRILON R47 by the supplier RHODIA, and the intermediate layer is of a polyethylene, such as those produced by the suppliers ATOFINA, ELENAC, or SOLVAY.

In a sixth embodiment, the inner and outer layers are of polyamide 12, such as those produced by the supplier CREANOVA under the references X7395 or LX9102, and the intermediate layer is of polyethylene.

In the above-described embodiments, the inner and outer layers are of thickness lying in the range about 0.1 millimeters (mm) to 0.4 mm and the intermediate layer is of thickness lying in the range about 0.6 mm to 1 mm.

By way of example, the inner and outer layers are of thickness of about 0.1 mm and the intermediate layer is of thickness of about 0.8 mm.

The hose of the invention can also be corrugated or smooth.

Naturally, the invention is not limited to the embodiment described and variants can be applied thereto without going beyond the ambit of the invention as defined by the claims.

In particular, the hose is usable in particular in any application for conveying inflammable liquids or gases whose flow generates electrostatic charge, or more generally is usable for any application requiring electrostatic charge to be evacuated.

1/ A multilayer hose comprising an outer layer, an intermediate layer, and an inner layer which are made of thermoplastic material, the hose being characterized in that the inner and outer layers include additives making the layers conductive.

2/ A multilayer hose according to claim 1, characterized in that the inner and outer layers have a surface resistivity of less than about 10⁶ ohms.

3/ A multilayer hose according to claim 1 or claim 2, characterized in that the layers are made from the same material.

4/ A multilayer hose according to claim 3, characterized in that the material used is polyamide 12.

5/ A multilayer hose according to claim 3, characterized in that the material used is polyamide 6.

6/ A multilayer hose according to claim 3, characterized in that the material used is a polyolefin.

7/ A multilayer hose according to claim 3, characterized in that the material used is a polyethylene.

8/ A multilayer hose according to claim 3, characterized in that the material used is a polyester.

9/ A multilayer hose according to claim 8, characterized in that the material used is polybutylene terphthalate.

10/ A multilayer hose according to claim 3, characterized in that the material used is a polyether-ester copolymer.

11/ A multilayer hose according to any preceding claim, characterized in that the inner and outer layers are of thickness lying in the range about 0.1 mm to 0.4 mm and the intermediate layer is of thickness lying in the range about 0.6 mm to 1 mm.

12/ A multilayer hose according to claim 11, characterized in that the inner and outer layers are of thickness of about 0.1 mm and the intermediate layer is of thickness of about 0.8 mm.
